(19) United States
(12) Patent Application Publication
(10) Pub. No.: US 2007/0279333 A1
(43) Pub. Date: Dec. 6, 2007

(54) Pulse amplitude modulation driver with fewer transistors for driving organic light-emitting diode display

(76) Inventor: Chang Oon Kim, Gwangju-si (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/445,125

(22) Filed: May 31, 2006

(51) Int. Cl. G09G 3/30

(52) U.S. Cl. 345/76

(57) ABSTRACT

An OLED driver circuit includes a plurality of current sources, where each current source comprises a first reference current generation circuit generating a first reference current, a second reference current generation circuit generating a second reference current, a first set of transistors coupled to the first reference current generation circuit and generating a first drive current based upon the first reference current in response to a first part of display data, and a second set of transistors coupled to the second reference current generation circuit and generating a second drive current based upon the second reference current in response to a second part of the display data. The first drive current and the second drive current are combined to generate the column drive current for driving OLED coupled to the column associated with said each current source. The second reference current is greater than the first reference current.

### BACKGROUND OF THE INVENTION

1. Field of the Invention

The present invention relates to an organic light-emitting diode (OLED) display panel driver and, more specifically, to a pulse amplitude modulation (PAM) driver with fewer transistors for generating the drive current for driving the OLED display panel.

2. Description of the Related Art

An OLED display panel is generally comprised of an array of organic light emitting diodes (OLEDs) that have carbon-based films or other organic material films between two charged electrodes, generally a metallic cathode and a transparent anode typically being glass. In general, the organic material films are comprised of a hole-injection layer, a hole-transport layer, an emissive layer and an electron-transport layer. When voltage is applied to the OLED cell, the injected positive and negative charges recombine in the emissive layer and create electro-luminescent light. Unlike liquid crystal displays (LCDs) that require backlighting, OLED displays are self-emissive devices—they emit light themselves rather than modulate transmitted or reflected light. Accordingly, OLEDs are brighter, thinner, faster and lighter than LCDs, and use less power, offer higher contrast and are cheaper to manufacture.

An OLED display panel is typically driven by an OLED driver including a row driver and a column driver. A row driver typically selects a row of OLEDs in the display panel, and the column driver provides driving current to one or more of the OLEDs in the selected row to light the selected OLEDs according to the display data.

FIG. 1 illustrates a conventional OLED display panel driven by a conventional OLED driver. The OLED display panel 100 comprises an array of OLEDs 102 coupled between the rows and columns of the display panel 100. The anodes of the OLEDs 102 are coupled to the columns ( . . . C(n−1), C(n), C(n+1), C(n+2) . . . ) and the cathodes of the OLEDs 102 are coupled to the rows ( . . . ROW(n−1), ROW(n), ROW(n+1), ROW(n+2) . . . ) of the display panel 100. The OLED display panel 100 is driven by an OLED driver including a row driver 120 and a column driver 140.

The row driver 120 includes row driver control circuitry (not shown) configured to couple the cathodes of the OLEDs 102 associated with a row ( . . . ROW(n−1), ROW(n), ROW(n+1), ROW(n+2) . . . ) of the display panel 100 to either a low voltage (e.g., GND) via resistors ( . . . RL(n−1), RL(n), RL(n+1), RL(n+2) . . . ) by closing the switches 126 and opening the switches 124 to select the row or to a high voltage (e.g., VCC) by closing the switches 124 and opening the switches 126 to unselect the row. For example, in FIG. 1, ROW(n) is shown selected with the switch 126 associated with ROW(n) being closed to couple ROW(n) to GND. The selection of ROW(n) by the row driver 120 couples ROW(n) to GND and thus forward-biases the OLEDs 102 coupled to ROW(n).

The column driver 140 includes current sources 142 that provide current ( . . . I(n−1), I(n), I(n+1), and I(n+2) . . . ) to the corresponding columns (C(n−1), C (n), C(n+1), C(n+2) . . . ) of the panel 100 to drive the OLEDs 102 on the columns. Once a row is selected by the row driver 120, the current sources 142 of the column driver 140 generate current ( . . . I(n−1), I(n), I(n+1), and I(n+2) . . . ) for the corresponding columns (C(n−1), C (n), C(n+1), C(n+2) . . . ) according to the corresponding display data ( . . . Idata(n−1), Idata(n), Idata(n+1), Idata(n+2) . . . ) to drives the OLEDs 102 on the selected row.

In a PAM type OLED driver, the current ( . . . I(n−1), I(n), I(n+1), and I(n+2) . . . ) is generated to be multiples of a unit driving current (e.g., Iw) and proportional to the display data ( . . . Idata(n−1), Idata(n), Idata(n+1), Idata(n+2) . . . ), and the brightness of the OLEDs 102 is also proportional to the associated driving current ( . . . I(n−1), I(n), I(n+1), and I(n+2) . . . ) for the corresponding column. For example, the display data may be 1-bit data indicating 2 levels of brightness, for example, bright (“1”) or dark (“0”), of the OLEDs 102. Thus, the current ( . . . I(n−1), I(n), I(n+1), I(n+2) . . . ) from the current sources 142 is generated to be, for example, 0 or Iw. For another example, the display data may be 2-bit data indicating 4 levels of brightness, for example, very dark (“0”), dark (“1”), bright (“2), and very bright (“3”), of the OLEDs 102. Thus, the current ( . . . I(n−1), I(n), I(n+1), I(n+2) . . . ) from the current sources 142 is generated to be, for example, 0, Iw, 2×Iw, or 3×Iw. The OLEDs 102 in the selected row (e.g., ROW(n)) are lit very brightly (3×Iw), brightly (2×Iw), dark (Iw), or are unlit (zero current) based upon the drive current ( . . . I(n−1), I(n), I(n+1), and I(n+2) . . . ) corresponding to the columns (C(n−1), C(n), C(n+1), C(n+2) . . . ) of the panel 100.

FIG. 2 illustrates an example of a conventional current source 142 in a conventional PAM type OLED driver. The example of FIG. 2 shows a current source 142 that generates drive current I(n) for driving the associated column C(n) in response to display data Idata(n) that is comprised of 8 bits (D0, D1, D2, . . . , D6, D7) in this example. A reference current generation circuit 202 generates a reference current Iw. Although each of the transistors 202, 204, 206, 208, 210, 212, 214, 216 is shown as a single transistor in FIG. 2 merely for simplicity of illustration, in fact each transistor 202, 204, 206, 208, 210, 212, 214, 216 is a group of transistors including 2^{N} transistors (N=0, 1, 2, 3, 4, 5, 6, 7, respectively) of the same size as indicated by the notation TR=1ea, TR=2ea, TR=4ea, TR=8ea, TR=16ea, TR=32ea, TR=64ea, and TR=128ea, respectively. For example, transistor group 208 in fact includes 8 (=2³) transistors of the same size as shown by the notation TR=8ea and transistor group 216 in fact includes 128 (=2⁷) transistors of the same size as shown by the notation TR=128ea.

Each of the 2^{N} transistors in the transistor groups 202, 204, 206, 208, 210, 212, 214, 216 forms current mirrors with the reference current generation circuit 202. The switches 218, 220, 222, 224, 226, 228, 230, 232 are opened or closed in response to bit DN (N=0, 1, 2, . . . , 7) of the display data Idata(n). For example, the switches 220, 222, 224, 226, 228, 230, 232 may be configured to be closed (ON) when the bit DN=1 (N=0, 1, 2, . . . , 7) to cause each of the transistors in the transistor groups 202, 204, 206, 208, 210, 212, 214, 216 to generate current adding to the drive current I(n) and open (OFF) when the bit DN=0 (N=0, 1, 2, . . . , 7) to disconnect the transistors 202, 204, 206, 208, 210, 212, 214, 216 from the current I(n). Since each of the transistor groups 202, 204, 206, 208, 210, 212, 214, 216 includes 2^{N} transistors (N=0, 1, 2, 3, 4, 5, 6, 7, respectively) of the same size, each of the transistor groups 202, 204, 206, 208, 210, 212, 214, 216 can generate current of 2^{N} multiple (N=0, 1, 2, 3, 4, 5, 6, 7) of the reference current Iw if the bit DN of the display data Idata(n) causes the corresponding switch 218,2 20, 222, 224, 226, 228, 230, 232 to close (ON). For example, in the example of FIG. 4, transistor group 202 can generate current of 1×Iw (=2⁰×Iw) if switch 218 is closed in response to D0=1, transistor group 204 can generate current of 2×Iw (=2¹×Iw) if switch 220 is closed in response to D1=1, transistor group 206 can generate current of 4×Iw (=2²×Iw) if switch 222 is closed in response to D2=1, transistor group 208 can generate current of 8×Iw (=2³×Iw) if switch 224 is closed in response to D3=1, transistor group 210 can generate current of 16×Iw (=2⁴×Iw) if switch 226 is closed in response to D4=1, transistor group 212 can generate current of 32×Iw (=2⁵×Iw) if switch 228 is closed in response to D5=1, transistor group 214 can generate current of 64×Iw (=2⁶×Iw) if switch 230 is closed in response to D6=1, and transistor group 216 can generate current of 128×Iw (=2⁸×Iw) if switch 232 is closed in response to D7=1. The column drive current I(n) is the sum of all the current generated by each of the transistors in all of the transistor groups 202, 204, 206, 208, 210, 212, 214, 216. Therefore, by controlling the bits DN (N=0, 1, 2, . . . , 7) of the display data Idata(n) for column C(n), it is possible to generate a column drive current I(n) of 256 different levels (0, 1, 2, 3 . . . , 255) to achieve 256 different levels of brightness in the OLED coupled to the column C(n) for a given selected row.

In order to accommodate for display data Idata(n) of 8 bits corresponding to 256 (=2⁸) (0, 1, 2, . . . , 255) brightness levels, it can be seen that the current source 142 requires 255 transistors (255=1+2+4+8+16+32+64+128=2⁸−1). If, for example, there are 100 columns in the OLED panel 100, the column driver 140 likewise includes 100 current sources 142 each having 255 transistors, resulting in 25500 (100×255) transistors just for generating the drive current for the OLED panel 100. In general, for an OLED panel 100 with A number of rows and B number of columns and capable of indicating 2^{C} number of brightness levels responsive to C bit display data, the conventional current sources 142 would require at least B×(2^{C}−1) transistors just for generating the drive current for the OLED panel 100. If gamma compensation is used with the OLED panel 100, even more transistors would be necessary to generate the drive current.

A large number of transistors directly results in increased chip size of the OLED driver that includes the column driver 140 and the row driver 120. A large chip size also means that it will be more costly to manufacture the OLED drivers. The larger chip size becomes even a more serious drawback especially with modern displays that require a very high number of brightness levels. As the number of required brightness levels increases, the display data requires more bits, which in turn exponentially increases the number of transistors required to generate the drive current for the OLED panels.

Therefore, there is a need for an OLED column driver that can generate the drive current for the OLED panel with fewer transistors.

### SUMMARY OF THE INVENTION

Embodiments of the present invention include a driver circuit for driving an organic light-emitting diode (OLED) display panel including a plurality of organic light-emitting diodes (OLEDs) arranged in rows and columns, where the driver includes a plurality of current sources for driving the OLEDs coupled to the columns and each current source has a significantly reduced number of transistors for generating the drive current. Each current source comprises a first reference current generation circuit generating a first reference current, a second reference current generation circuit generating a second reference current different from the first reference current, a first set of transistors coupled to the first reference current generation circuit and generating a first drive current based upon the first reference current in response to a first part of the display data indicative of a brightness level of the OLED coupled to the column associated with said each current source, and a second set of transistors coupled to the second reference current generation circuit and generating a second drive current based upon the second reference current in response to a second part of the display data. The first drive current and the second drive current are combined to generate the column drive current for driving the OLED coupled to the column associated with said each current source. The second reference current can be greater than the first reference current.

In one embodiment, the first set of transistors comprises P groups of transistors and the second set of transistors comprises Q groups of transistors, where P and Q are integers not less than 1. P may be different from Q. Each of the P groups of transistors comprises 2^{R} transistors of substantially the same size where R is an integer not less than 0 but not more than P−1, and each of the Q groups of transistors comprises 2^{S} transistors of substantially the same size where S is an integer not less than 0 but not more than Q−1. Each of the 2^{R} transistors is coupled to the first reference current generation circuit and capable of generating the same first reference current in response to the display data and each of the 2^{S} transistors is coupled to the second reference current generation circuit and capable of generating the same second reference current in response to the display data. Thus, each of the P groups of transistors is capable of generating a 2^{R} multiple of the first reference current and each of the Q groups of transistors is generating a 2^{S} multiple of the second reference current. The second reference current may be 2^{P} times greater than the first reference current, and the display data can be comprised of P+Q bits, where each of the P groups of transistors and the Q groups of transistors is associated with a corresponding one of the P+Q bits of the display data.

Thus, the OLED drive circuit according to the present invention has the advantage that significantly fewer transistors are required in the current source to generate the column drive current, by use of two or more reference current generation circuits generating different values of reference currents together with two or more sets of transistors generating current based on the different values of the reference currents. Fewer transistors in the current sources of the OLED drive circuit results in a significant decrease in the chip size required for the column driver and in turn a significant increase of the production yield in fabricating the integrated circuit (IC) for the OLED controller.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates a conventional OLED display panel driven by a conventional OLED driver.

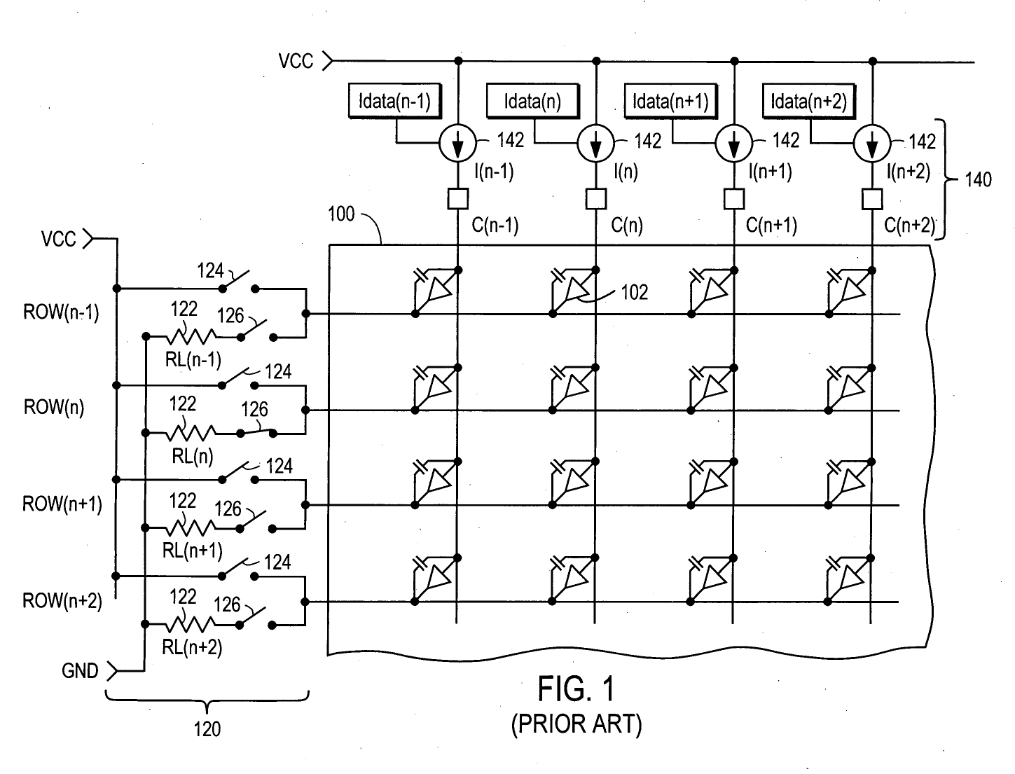

FIG. 2 illustrates an example of a conventional current source in a conventional PAM type OLED driver.

FIG. 3 illustrates an example of a current source in a PAM type OLED driver, according to one embodiment of the present invention.

FIG. 4 is a flowchart illustrating the process of generating drive current for an OLED panel, according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

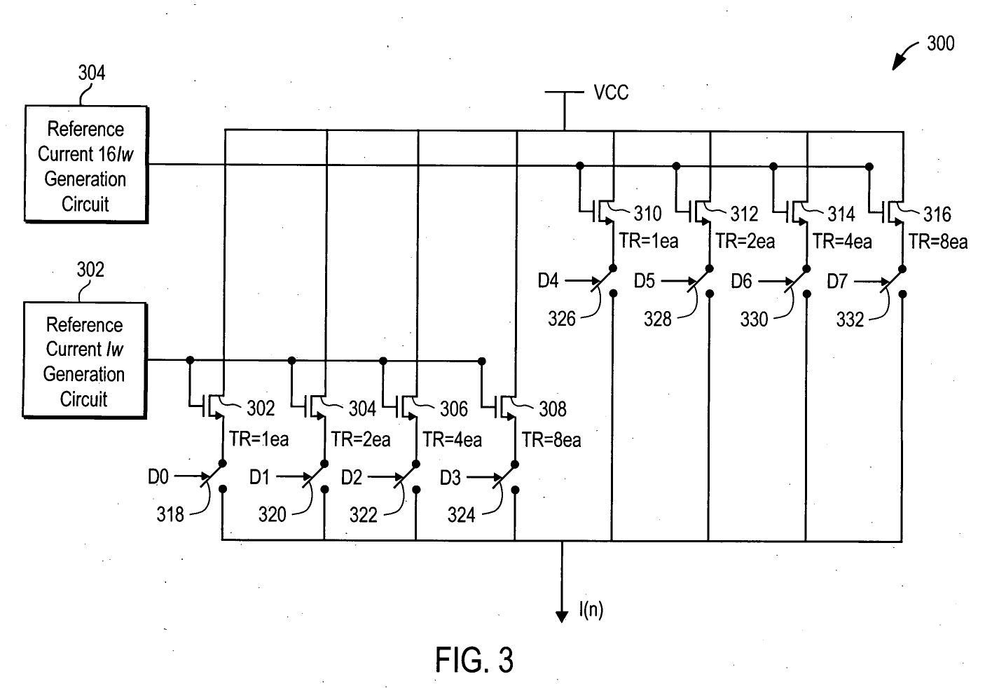

FIG. 3 illustrates an example of a current source in a PAM type OLED driver, according to one embodiment of the present invention. The embodiment of FIG. 3 shows a current source 300 that can replace the conventional current source 142 to generate drive current I(n) for driving OLEDs in the associated column C(n) in response to display data Idata(n) that is comprised of 8 bits (D0, D1, D2, . . . , D6, D7). Although the embodiment of FIG. 3 illustrates a current source 300 that is responsive to 8 bit display data Idata(n), note that the current source in accordance with the present invention can be used to generate OLED drive current corresponding to display data of any number of bits for displaying any number of levels of brightness.

The current source 300 includes a first set of transistors including P groups of transistors (P is an integer not less than 1) and a second set of transistors including Q groups of transistors (Q is an integer not less than 1). Note that P may be equal to or different from Q. In the example of FIG. 3, the first set of transistors include 4 (P=4) transistor groups 302, 304, 306, 308 and the second set of transistors include 4 (Q=4) transistor groups 310, 312, 314, 316. Although each of the transistor groups 302, 304, 306, 308, 310, 312, 314, 316 is shown as a single transistor in FIG. 3 merely for simplicity of illustration, in fact each transistor group 302, 304, 306, 308, is a group of transistors including 2^{R} transistors (R=0, 1, 2, . . . P−1, respectively) of substantially the same size and each transistor group 310, 312, 314, 316 is a group of transistors including 2^{S} transistors (S=0, 1, 2, . . . Q−1, respectively) of substantially the same size. For example, in the embodiment shown in FIG. 3, transistor group 302 includes 1 (=2⁰) transistor as shown by the notation TR=1ea, transistor group 304 includes 2 (=2¹) transistors of substantially the same size as shown by the notation TR=2ea, transistor group 306 includes 4 (=2²) transistors of substantially the same size as shown by the notation TR=4ea, and transistor group 308 includes 8 (=2³=2⁴⁻¹) transistors of substantially the same size as shown by the notation TR=8ea. Likewise, transistor group 310 includes 1 (=2⁰) transistors as shown by the notation TR=1ea, transistor group 312 includes 2 (=2¹) transistors of substantially the same size as shown by the notation TR=2ea, transistor group 314 includes 4 (=2²) transistors of substantially the same size as shown by the notation TR=4ea, and transistor group 316 includes 8 (=2³=2⁴⁻¹) transistors of substantially the same size as shown by the notation TR=8ea. The combined number of the transistors in the transistor groups 302, 304, 306, 308 of the first set of transistors is 2^{P}−1, and the combined number of the transistors in the transistor groups 310, 312, 314, 316 of the second set of transistors is 2^{Q}−1, and the total number of transistors in the first and second set of transistors is (2^{P}−1)+(2^{Q}−1). For example, the total number of transistors in the first and second sets of transistors in the embodiment of FIG. 3 is only 30 (=(2⁰+2¹+2²+2³)+(2⁰+2¹+2²+2³)=(2⁴−1)+(2⁴−1)).

A first reference current generation circuit 302 generates a first reference current, and a second reference current generation circuit 304 generates a second reference current different from the first reference current. The second reference current is typically larger than the first reference current, and can be larger than the largest current generated by any one of the transistor groups 302, 304, 306, 308 in the first set of transistors. In one embodiment, the first reference current is Iw and the second reference current is 2^{P}×Iw, where P is the number of transistor groups in the first set of transistors. Thus, in the example shown in FIG. 3, the first reference current is Iw and the second reference current is 2⁴×Iw=16×Iw.

Each of the 2^{R} transistors in each of the transistor groups 302, 304, 306, 308 forms a current mirror with the first reference current generation circuit 302 that generates the first reference current Iw. Each of the 2^{S} transistors in each of the transistor groups 310, 312, 314, 316 forms a current mirror with the second reference current generation circuit 304 that generates the second reference current 2^{P}×Iw, where P is the number of transistor groups in the first set of transistors. The switches 318, 320, 322, 324, 326, 328, 330, 332 are opened or closed in response to bit DN (N=0, 1, 2, . . . , 7) of the display data Idata(n). For example, the switches 318, 320, 322, 324, 326, 328, 330, 332 may be configured to be closed (ON) when the bit DN=1 (N=0, 1, 2, . . . , 7) in order to connect the transistor groups 302, 304, 306, 308, 310, 312, 314, 316 to the current I(n) and open (OFF) when the bit DN=0 (N=0, 1, 2, . . . , 7) in order to disconnect the transistors 302, 304, 306, 308, 310, 312, 314, 316 from the current I(n). The transistor groups 302, 304, 306, 308 of the first set of transistors generates a first part of the column drive current I(n) in response to bits D0, D1, D2, and D3 of the display data Idata(n), and transistor groups 310, 312, 314, 316 of the second set of transistors generates a second part of the column drive current I(n) in response to bits D4, D5, D6, and D7 of the display data Idata(n).

Since each of the transistor groups 302, 304, 306, 308 includes 2^{R} transistors (R=0, 1, 2, . . . P−1, respectively), each of the transistor groups 302, 304, 306, 308 can generate current of 2^{R} multiples (R=0, 1, 2, . . . P−1, respectively) of the first reference current Iw in response to bits D0, D1, D2, and D3, respectively, of the display data Idata(n). In addition, since each of the transistor groups 310, 312, 314, 316 includes 2^{S} transistors (S=0, 1, 2, . . . Q−1, respectively), each of the transistor groups 310, 312, 314, 316 can generate current of 2^{S} multiples (S=0, 1, 2, . . . Q−1, respectively) of the second reference current 2^{P}×Iw in response to bits D4, D5, D6, and D7, respectively, of the display data Idata(n). For example, if all the switches 318, 320, 322, 324, 326, 328, 330, 332 are closed in response to the display data Idata(n) (D0, D1, . . . , D7) in the embodiment of FIG. 3 where P=4, Q=4, R=0, 1, 2, 3, and S=0, 1, 2, 3, transistor group 302 generates current of 1×Iw (=2⁰×Iw), transistor group 304 generates current of 2×Iw (=2¹×Iw), transistor group 306 generates current of 4×Iw (=2²×Iw), transistor group 308 generates current of 8×Iw (=2³×Iw), transistor group 310 generates current of 16×Iw (=2⁰×2⁴×Iw), transistor group 312 generates current of 32×Iw (=2¹×2⁴×Iw), transistor group 314 generates current of 64×Iw (=2²×2⁴×Iw), and transistor group 316 generates current of 128×Iw (=2⁴×2⁴×Iw).

The column drive current I(n) is the sum of all the current generated by all of the transistor groups 302, 304, 306, 308, 310, 312, 314, 316. Therefore, by controlling the bits DN (N=0, 1, 2, . . . , 7) of the display data Idata(n) for column C(n), it is possible to generate column drive current I(n) of 256 (=2⁸) different levels (0, 1, 2, . . . , 255) to achieve 256 different levels of brightness in the OLED coupled to the column C(n). In general, for an OLED panel 100 with A number of rows and B number of columns and capable of indicating 2^{C} number of brightness levels responsive to C bit display data, the current source 300 of the present invention merely requires B×((2^{P}−1)+(2^{Q}−1)) transistors just for generating the drive current for the OLED panel 100.

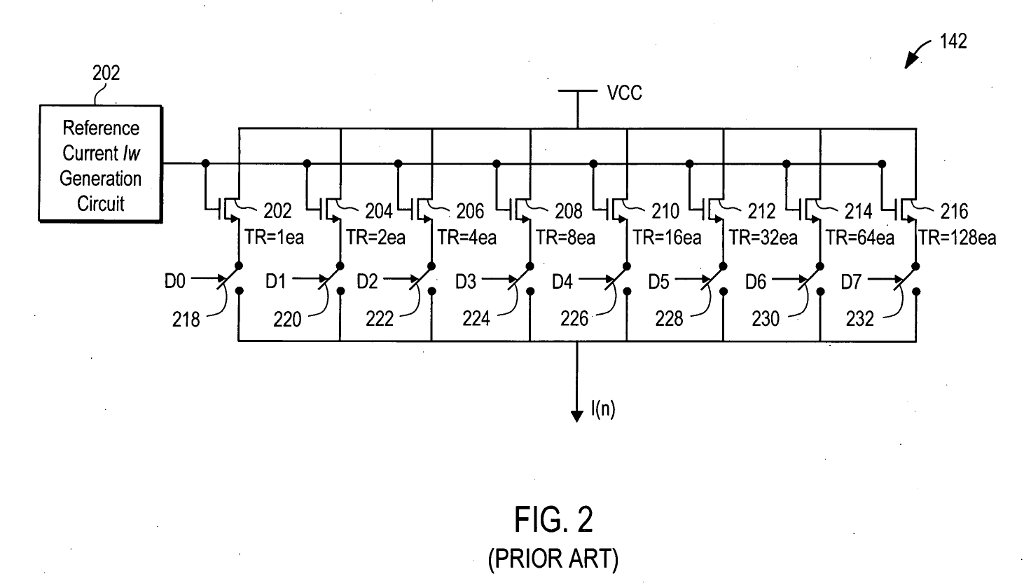

For example, note that the current source 300 of FIG. 3 is able to generate the same 256 different levels of the column drive current I(n) with only 30 (=(2⁴−1)+(2⁴−1)) transistors in the first and second set of transistors, as compared to the conventional current generator 142 of FIG. 2 which requires 255 transistors. If the OLED panel 100 includes 100 columns, for example, the difference in the number of transistors is drastic, with only 3000 (=100×30) transistors required with the current generator 300 of FIG. 3 according to the present invention to generate 256 different levels of the column drive current while 25500 (=100×255) transistors are required with the conventional current generator 142 of FIG. 2. Thus, the current source 300 of FIG. 3 enables reduction of the number of transistors required to approximately 12% of what is required in conventional current source 142 of FIG. 2, resulting in a very significant decrease in the chip size required for the column driver 140 and a very significant increase of production yield in the IC fabrication process for the OLED driver.

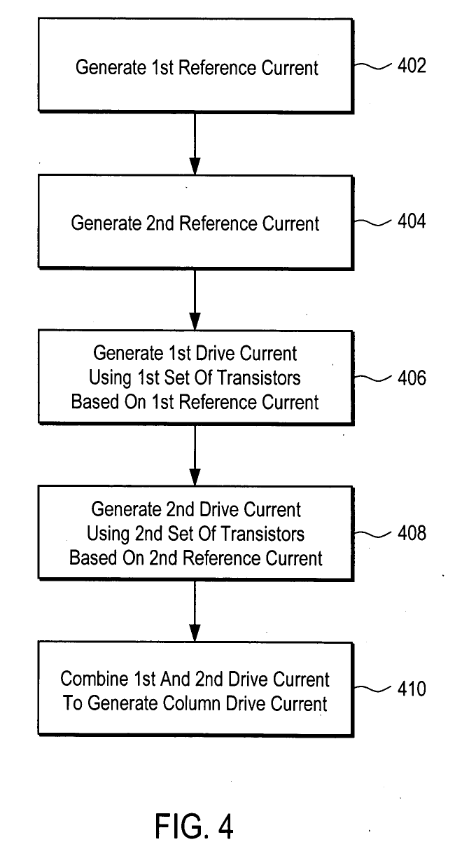

FIG. 4 is a flowchart illustrating the process of generating column drive current for an OLED panel, according to one embodiment of the present invention. A first reference current is generated 402, and a second reference current different from the first reference current is also generated 404. A first drive current is generated 406 using a first set of transistors based on the first reference current, and a second drive current is generated 408 using a second set of transistors based on the second reference current. The first drive current and the second drive current are combined 410 to generate the column drive current for the corresponding column of the OLED panel. The second reference current is typically larger than the first reference current, and can be larger than (e.g., twice as large as) the largest current generated by any one of the transistor groups in the first set of transistors. Although the steps 402, 404, 406, 408, 41.0 are illustrated sequentially in FIG. 4, note that all or some of these steps may be performed substantially at the same time or in a different order. Thus, the process of FIG. 4 is not limited to the specific order in which the steps 402, 404, 406, 408, 410 are illustrated.

Upon reading this disclosure, those of ordinary skill in the art will appreciate still additional alternative structural and functional designs for a system and a process for generating column drive current for an OLED panel in response to display data through the disclosed principles of the present invention. For example, the present invention is not limited to the two sets of transistors generating drive current based on the first and second reference currents generated by the first and second reference current generation circuits. Rather, the present invention can be similarly applied to more than 2 transistor sets generating drive current based on different reference current generated by more than two reference current generation circuits.

Thus, while particular embodiments and applications of the present invention have been illustrated and described, it is understood that the invention is not limited to the precise construction and components disclosed herein. Various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A driver circuit for driving an organic light-emitting diode (OLED) display panel including a plurality of organic light-emitting diodes (OLEDs) arranged in rows and columns, the driver circuit including a plurality of current sources for driving the OLEDs coupled to the columns, each current source comprising:
a first reference current generation circuit generating a first reference current;
a second reference current generation circuit generating a second reference current different from the first reference current;
a first set of transistors coupled to the first reference current generation circuit and generating a first drive current based upon the first reference current in response to a first part of display data indicative of a brightness level of the OLED coupled to the column associated with said each current source; and
a second set of transistors coupled to the second reference current generation circuit and generating a second drive current based upon the second reference current in response to a second part of the display data, the first drive current and the second drive current being combined to generate column drive current for driving the OLED coupled to the column associated with said each current source.

2. The driver circuit of claim 1, wherein the second reference current is greater than the first reference current.

3. The driver circuit of claim 1, wherein the first set of transistors comprises P groups of transistors and the second set of transistors comprises Q groups of transistors, P and Q being integers not less than 1.

4. The driver circuit of claim 3, wherein P is equal to Q.

5. The driver circuit of claim 3, wherein the second reference current is greater than a largest current generated by any one of the Q groups of transistors.

6. The driver circuit of claim 3, wherein each of the P groups of transistors comprises 2^{R} transistors of substantially same size where R is an integer not less than 0 but not more than P−1, and each of the Q groups of transistors comprises 2^{S} transistors of substantially the same size where S is an integer not less than 0 but not more than Q−1.

7. The driver circuit of claim 6, wherein each of the 2^{R} transistors is coupled to the first reference current generation circuit and capable of generating the same first reference current in response to the display data and each of the 2^{S} transistors is coupled to the second reference current generation circuit and capable of generating the same second reference current in response to the display data.

8. The driver circuit of claim 7, wherein each of the P groups of transistors is capable of generating a 2^{R} multiple of the first reference current and each of the Q groups of transistors is capable of generating a 2^{S} multiple of the second reference current.

9. The driver circuit of claim 7, wherein the second reference current is 2^{P} times greater than the first reference current.

10. The driver circuit of claim 3, wherein the display data is comprised of P+Q bits, and each of the P groups of transistors and the Q groups of transistors is associated with a corresponding one of the P+Q bits.

11. The driver circuit of claim 10, further comprising:
a first set of P switches each coupled to a corresponding one of the P groups of transistors causing the 2^{R} transistors in said corresponding one of the P groups of transistors to generate the same first reference current in response to the display data; and
a second set of Q switches each coupled to a corresponding one of the Q groups of transistors causing the 2^{S} transistors in said corresponding one of the Q groups of transistors to generate the same second reference current in response to the display data.

12. A driver circuit for driving an organic light-emitting diode (OLED) display panel including a plurality of organic light-emitting diodes (OLEDs) arranged in rows and columns, the driver circuit including a plurality of current sources for driving the OLEDs coupled to the columns, each of the current sources generating a column drive current corresponding to an associated column in response to display data indicative of a brightness level of the OLED coupled to the associated column, each current source comprising:
a first reference current generation circuit generating a first reference current;
a second reference current generation circuit generating a second reference current different from the first reference current;
a first set of transistors including P groups of transistors, each of the P groups of transistors including 2^{R} transistors of substantially same size where P is an integer not less than 1 and R is an integer not less than 0 but not more than P−1, each of the P groups of transistors coupled to the first reference current generation circuit and being capable of generating a 2^{R} multiple of the first reference current to generate in combination a first drive current in response to P bits of the display data; and
a second set of transistors including Q groups of transistors, each of the Q groups of transistors including 2^{S} transistors of substantially the same size where Q is an integer not less than 1 and S is an integer not less than 0 but not more than Q−1, each of the Q groups of transistors coupled to the second reference current generation circuit and being capable of generating a 2^{S} multiple of the second reference current to generate in combination a second drive current in response to Q bits of the display data, the first drive current and the second drive current being combined to generate the column drive current corresponding to the associated column.

13. The driver circuit of claim 12, wherein P is equal to Q.

14. The driver circuit of claim 12, wherein the second reference current is 2^{P} times greater than the first reference current.

15. The driver circuit of claim 12, further comprising:
a first set of P switches each coupled to a corresponding one of the P groups of transistors enabling the corresponding one of the P groups of transistors to generate the 2^{R} multiple of the first reference current if said each of the P switches is closed; and
a second set of Q switches each coupled to a corresponding one of the Q groups of transistors enabling the corresponding one of the Q groups of transistors to generate the 2^{S} multiple of the second reference current if said each of the Q switches is closed.

16. An organic light-emitting diode (OLED) display device comprising:
an OLED display panel including a plurality of organic light emitting diodes (OLEDs) arranged in rows and columns; and
a driver circuit including a plurality of current sources for driving the OLEDs coupled to the columns, each current source comprising:
a first reference current generation circuit generating a first reference current;
a second reference current generation circuit generating a second reference current different from the first reference current;
a first set of transistors coupled to the first reference current generation circuit and generating a first drive current based upon the first reference current in response to a first part of display data indicative of a brightness level of the OLED coupled to the column associated with said each current source; and
a second set of transistors coupled to the second reference current generation circuit and generating a second drive current based upon the second reference current in response to a second part of the display data, the first drive current and the second drive current being combined to generate column drive current for driving the OLED coupled to the column associated with said each current source.

17. The OLED display device of claim 16, wherein the second reference current is greater than the first reference current.

18. The OLED display device of claim 16, wherein the first set of transistors comprises P groups of transistors and the second set of transistors comprises Q groups of transistors, P and Q being integers not less than 1.

19. The OLED display device of claim 18, wherein P is equal to Q.

20. The OLED display device of claim 18, wherein the second reference current is greater than a largest current generated by any one of the Q groups of transistors.

21. The OLED display device of claim 18, wherein each of the P groups of transistors comprises 2^{R} transistors of substantially same size where R is an integer not less than 0 but not more than P−1, and each of the Q groups of transistors comprises 2^{S} transistors of substantially the same size where S is an integer not less than 0 but not more than Q−1.

22. The OLED display device of claim 21, wherein each of the 2^{R} transistors is coupled to the first reference current generation circuit and capable of generating the same first reference current in response to the display data and each of the 2^{S} transistors is coupled to the second reference current generation circuit and capable of generating the same second reference current in response to the display data.

23. The OLED display device of claim 21, wherein each of the P groups of transistors is capable of generating a 2^{R} multiple of the first reference current and each of the Q groups of transistors is capable of generating a 2^{S} multiple of the second reference current.

24. The OLED display device of claim 21, wherein the second reference current is 2^{P} times greater than the first reference current.

25. The OLED display device of claim 18, wherein the display data is comprised of P+Q bits, and each of the P groups of transistors and the Q groups of transistors is associated with a corresponding one of the P+Q bits of the display data.

26. The OLED display device of claim 25, wherein the driver circuit further comprises:
a first set of P switches each coupled to a corresponding one of the P groups of transistors causing the 2^{R} transistors in said corresponding one of the P groups of transistors to generate the same first reference current in response to the display data; and
a second set of Q switches each coupled to a corresponding one of the Q groups of transistors causing the 2^{S} transistors in said corresponding one of the Q groups of transistors to generate the same second reference current in response to the display data.

27. An organic light-emitting diode (OLED) display device comprising:
an OLED display panel including a plurality of organic light emitting diodes (OLEDs) arranged in rows and columns; and
a driver circuit including a plurality of current sources for driving the OLEDs coupled to the columns, each current source generating a column drive current corresponding to an associated column in response to display data indicative of a brightness level of the OLED coupled to the associated column, each current source comprising:
a first reference current generation circuit generating a first reference current;
a second reference current generation circuit generating a second reference current different from the first reference current;
a first set of transistors including P groups of transistors, each of the P groups of transistors including 2^{R} transistors of substantially same size where P is an integer not less than 1 and R is an integer not less than 0 but not more than P−1, each of the P groups of transistors coupled to the first reference current generation circuit and being capable of generating a 2^{R} multiple of the first reference current to generate in combination a first drive current in response to P bits of the display data; and
a second set of transistors including Q groups of transistors, each of the Q groups of transistors including 2^{S} transistors of substantially the same size where Q is an integer not less than 1 and S is an integer not less than 0 but not more than Q−1, each of the Q groups of transistors coupled to the second reference current generation circuit and being capable of generating a 2^{S} multiple of the second reference current to generate in combination a second drive current in response to Q bits of the display data, the first drive current and the second drive current being combined to generate the column drive current corresponding to the associated column.

28. The OLED display device of claim 27, wherein P is equal to Q.

29. The OLED display device of claim 27, wherein the second reference current is 2^{P} times greater than the first reference current.

30. The OLED display device of claim 27, wherein the driver circuit further comprises:
a first set of P switches each coupled to a corresponding one of the P groups of transistors enabling the corresponding one of the P groups of transistors to generate the 2^{R} multiple of the first reference current if said each of the P switches is closed; and
a second set of Q switches each coupled to a corresponding one of the Q groups of transistors enabling the corresponding one of the Q groups of transistors to generate the 2^{S} multiple of the second reference current if said each of the Q switches is closed.

31. In a driver for driving an organic light-emitting diode (OLED) display panel including a plurality of organic light emitting diodes (OLEDs) arranged in rows and columns, a method of generating a column drive current for driving the OLED coupled to an associated column, the method comprising:
generating a first reference current;
generating a second reference current different from the first reference current;
generating a first drive current based upon the first reference current in response to a first part of display data indicative of a brightness level of the OLED coupled to the associated column;
generating a second drive current based upon the second reference current in response to a second part of the display data; and
combining the first drive current and the second drive current to generate the column drive current for driving the OLED coupled to the associated column.

32. The method of claim 31, wherein the second reference current is greater than the first reference current.
